(19) United States
(12) Patent Application Publication
(10) Pub. No.: US 2025/0341876 A1
(43) Pub. Date: Nov. 6, 2025

(54) POWER SUPPLY CONFIGURATION BASED POWER CAPPING

(71) Applicant: INTERNATIONAL BUSINESS MACHINES CORPORATION, ARMONK, NY (US)

(72) Inventors: NICOLE SCHWARTZ NETT, AUSTIN, TX (US); DEREK HOWARD, ROCHESTER, MN (US); MARTHA ANN BROYLES, AUSTIN, TX (US); RUBY M ZGABAY, AUSTIN, TX (US); SHELDON RAY BAILEY, ROCHESTER, MN (US)

(21) Appl. No.: 18/652,449

(22) Filed: May 1, 2024

(51) Int. Cl. G06F 1/26

(52) U.S. Cl. CPC G06F 1/263

(57) ABSTRACT

Power supply configuration based power capping includes determining, by a power management controller of a computing system that includes one or more power supply units, power supply configuration information for the computing system, including a total number of the power supply units, a power supply type for each of the power supply units, and a power supply input voltage for each of the power supply units. The power management controller determines, based on the power supply configuration information, a system power cap for the computing system. The power management controller controls power consumption of the computing system based on the system power cap.

### BACKGROUND

The present disclosure relates to methods, apparatus, and products for power supply configuration based power capping.

### SUMMARY

According to embodiments of the present disclosure, various methods, apparatus and products for power supply configuration based power capping are described herein. In some aspects, power supply configuration based power capping includes determining, by a power management controller of a computing system that includes one or more power supply units, power supply configuration information for the computing system, including a total number of the power supply units, a power supply type for each of the power supply units, and a power supply input voltage for each of the power supply units. The power management controller determines, based on the power supply configuration information, a system power cap for the computing system. The power management controller controls power consumption of the computing system based on the system power cap.

### BRIEF DESCRIPTION OF THE DRAWINGS

FIG. 1 sets forth an example computing environment according to aspects of the present disclosure.

FIG. 2 sets forth an example system for power supply configuration based power capping according to aspects of the present disclosure.

FIG. 3 sets forth example power supply configuration variations according to aspects of the present disclosure.

FIGS. 4A and 4B set forth a flowchart of an example method for power supply configuration based power capping according to aspects of the present disclosure.

FIG. 5 sets forth a flowchart of an example method for power supply configuration based power capping according to further aspects of the present disclosure.

### DETAILED DESCRIPTION

Power consumption is an important factor in computing system design for reasons as diverse as maximizing hardware efficiency, increasing computing density and reducing capital costs. Much effort has been spent in reducing the amount of power consumed by a computing system. In fact, many computing systems include processors and hardware dedicated to power management. Some implementations can include centralized hardware, such as a single dedicated processor, which performs the power management operations. Some implementations include distributed power management hardware, allowing simpler power management hardware to control a subset of the system components, resulting in more responsive power management, greater efficiency, etc.

General purpose computer systems are, by definition, designed to cover a large variety of usages. Systems allow for flexibility in configurations and features to satisfy various use cases, workloads, markets sectors, environments, and locations. This flexibility extends to the power subsystem of the computer, where different configurations of power supplies could be desired. Using varying power supply configurations adds complexity to the system, such that the power supply configuration chosen drives the maximum amount of power that can be supported in the computer.

A computer system may use power caps to prevent the system from trying to use power that is not available, which could cause errors, cause the system to crash, or in highly reliable systems, cause reduction of power allowed by parts of the system, impacting function and performance. Adding even further to the complexity is the support of redundant power supplies in systems, with multiple power caps when full power supply redundancy is present versus when redundancy is not present.

A power cap for a computing system is a limit on the amount of power it can consume. For example, a data center is generally designed to allow for a particular maximum amount of power to be drawn by all systems in the data center. This power cap can be divided among the various structures in the data center. For example, each rack can have its own power cap and each computing system in a rack can have a power cap, where each power cap is a subset of the next power cap in the hierarchy. While the power caps can be divided unevenly (e.g., one computing system in a rack can have a higher power cap than another) and the power caps can change dynamically, the total amount of power used by the computing systems in a particular rack generally cannot exceed the rack power cap. The power caps can funnel down to the computing system components as well. The power cap on the computing system can then be split among the internal components. The power consumption of the internal components may be managed by the computing system's power management system.

Previously, there has been limited granularity to cap the maximum power consumption of a computing system based on the power subsystem. Some systems may use a single power cap specific to that type of system. When a system supports multiple types of power supplies on a single system, code may determine which type is installed and a power cap may be set accordingly. There may also be an ability to trigger a redundant versus non-redundant mode for scenarios in which power supplies are failing, removed, or added. However, some such solutions may not account for the ability to populate different numbers of power supplies for the purpose of providing more or less power in the system, and may not consider the line cord input voltage, which could impact the output power provided by the power supplies. Some solutions may require each type of power supply to have a specific line cord input voltage.

Some examples disclosed herein are directed to a method to set a granular power cap for a system, taking into account not only the types of power supplies that are populated, but also the number of power supplies populated and the line cord input voltage. In some examples, changing the number of power supplies, and/or input voltage, and/or supply type may automatically result in updated power limits being determined and applied. In some examples, the firmware on the system examines the types of power supplies installed that are providing power, the number of power supplies that are installed in the system, and the type of the line cord input voltages attached to each of those power supplies, and determines a power cap specific to that configuration. The power supplies may detect the input voltage level that they are attached to and provide this information to system software. Using a rules-based framework, the firmware may determine what the maximum power cap for the system is when in redundant mode and when in non-redundant mode. Included in the rules-based framework according to some examples is a priority list of power supply types and input voltages, allowing the firmware to determine a power cap when mixed power supply configurations exist in a system. This creates an accurate maximum power cap for the system, so the desired system configuration can be supported, but the system does not try to use power not available.

Some examples disclosed herein support multiple power caps that may be varied based on configuration information including multiple variables. In some examples, system software uses available configuration information regarding power supplies to determine a system configuration and set a power cap unique for each combination. Some examples support granularity in power supply configuration and being able to protect the system from going over the supplied power. Some examples allow usage of fewer or different types of power supplies when appropriate and no fixed power supply type to line cord input voltage relationship. The overall cost of the system can be reduced when using fewer power supplies or different types of power supplies. This results in reduced price to the customer by allowing them to purchase perhaps a type of supplies that is less expensive as long as it meets their needs, or fewer power supplies, which then requires fewer line cords and fewer power distribution units. Having the configuration based power capping capability allows the ability to tune the power supply configuration to the system requirements.

Supporting multiple line cord input voltages may be a hard requirement for some customers or in some markets, typically based on the geography and use cases. Voltage ranges around the world may include low-line 110-127V and high-line 220-240V, as well as others, including, for example, Telco 48V DC inputs and high voltage 600V inputs. By allowing the same type of power supply to support different line cord input voltages, there is more volume on the power supply type and no need for an additional type of power supply to be developed and manufactured, reducing non-recurring engineering (NRE) costs and unit cost. There are sustainability aspects also. Fewer parts in general need to be produced. Power supplies are also usually heavy parts of the system, so fewer supplies in a system could result in more efficient shipping.

An example of the present disclosure is directed to a method for power supply configuration based power capping, which includes determining, by a power management controller of a computing system that includes one or more power supply units, power supply configuration information for the computing system, including a total number of the power supply units, a power supply type for each of the power supply units, and a power supply input voltage for each of the power supply units. The method includes determining, by the power management controller based on the power supply configuration information, a system power cap for the computing system. The method includes controlling, by the power management controller, power consumption of the computing system based on the system power cap.

Examples of the method include various technical features that yield technical effects that provide various improvements to computer technology. For instance, some examples include the technical features of determining power supply configuration information for a computing system that includes one or more power supply units, including a total number of the power supply units, a power supply type for each of the power supply units, and a power supply input voltage for each of the power supply units; determining, based on the power supply configuration information, a system power cap for the computing system; and controlling power consumption of the computing system based on the system power cap. These technical features yield the technical effect of providing support for multiple power caps that may be varied based on configuration information including multiple variables. Some examples support granularity in power supply configuration and being able to protect the system from going over the supplied power. Some examples allow usage of fewer or different types of power supplies when appropriate and no fixed power supply type to line cord input voltage relationship. Having the configuration based power capping capability allows the ability to tune the power supply configuration to the system requirements.

Some examples of the method further include determining, by the power management controller based on the power supply type for each of the power supply units, a system level power supply type, where the system power cap for the computing system is determined based on the system level power supply type. These technical features yield the technical effect of being able to determine an accurate system power cap when mixed power supply types exist in the computing system.

Some examples of the method further include determining, by the power management controller based on the power supply input voltage for each of the power supply units, a system level power supply input voltage, where the system power cap for the computing system is determined based on the system power supply input voltage. These technical features yield the technical effect of being able to determine an accurate system power cap when mixed power supply input voltages exist in the computing system.

In some examples of the method, the system power cap comprises a redundant power limit when the computing system includes one or more redundant power supply units. These technical features yield the technical effect of being able to determine an accurate system power cap when the computing system is in a redundant mode, such as using a higher limit than might be used in a non-redundant mode.

In some examples of the method, the system power cap comprises a non-redundant power limit when the computing system does not include a redundant power supply unit. These technical features yield the technical effect of being able to determine an accurate system power cap when the computing system is in a non-redundant mode, such as using a lower limit than might be used in a redundant mode.

Some examples of the method further include determining, by the power management controller after a power supply unit has been added to or removed from the computing system, an updated version of the power supply configuration information. These technical features yield the technical effect of being able to dynamically update the power supply configuration information when the number of power supply units in the computing system changes.

Some examples of the method further include determining, by the power management controller based on the updated version of the power supply configuration information, an updated system power cap for the computing system; and controlling, by the power management controller, power consumption of the computing system based on the updated system power cap. These technical features yield the technical effect of providing the ability to populate different numbers of power supply units and determine an accurate system power cap based on the current configuration and as the configuration changes.

Some examples of the method further include determining whether the power supply configuration information indicates an invalid power supply configuration; and generating a warning indicating an invalid power supply configuration. These technical features yield the technical effect of helping to ensure an accurate system power cap and protecting the computing system from going over the supplied power.

Another example of the present disclosure is directed to an apparatus, which includes a processing device, and a memory operatively coupled to the processing device. The memory stores computer program instructions that, when executed, cause the processing device to: determine power supply configuration information for a computing system, including a total number of power supply units in the computing system, a power supply type for each of the power supply units, and a power supply input voltage for each of the power supply units; determine, based on the power supply configuration information, a system power cap for the computing system; and control power consumption of the computing system based on the system power cap.

Examples of the apparatus include various technical features that yield technical effects that provide various improvements to computer technology. For instance, some examples include the technical features of determine power supply configuration information for a computing system, including a total number of power supply units in the computing system, a power supply type for each of the power supply units, and a power supply input voltage for each of the power supply units; determine, based on the power supply configuration information, a system power cap for the computing system; and control power consumption of the computing system based on the system power cap. These technical features yield the technical effect of providing support for multiple power caps that may be varied based on configuration information including multiple variables. Some examples support granularity in power supply configuration and being able to protect the system from going over the supplied power. Some examples allow usage of fewer or different types of power supplies when appropriate and no fixed power supply type to line cord input voltage relationship. Having the configuration based power capping capability allows the ability to tune the power supply configuration to the system requirements.

In some examples of the apparatus, the memory further stores computer program instructions that, when executed, cause the processing device to determine, based on the power supply type for each of the power supply units, a system level power supply type, where the system power cap for the computing system is determined based on the system level power supply type. These technical features yield the technical effect of being able to determine an accurate system power cap when mixed power supply types exist in the computing system.

In some examples of the apparatus, the memory further stores computer program instructions that, when executed, cause the processing device to determine, based on the power supply input voltage for each of the power supply units, a system level power supply input voltage, where the system power cap for the computing system is determined based on the system power supply input voltage. These technical features yield the technical effect of being able to determine an accurate system power cap when mixed power supply input voltages exist in the computing system.

In some examples of the apparatus, the system power cap comprises a redundant power limit when the computing system includes one or more redundant power supply units. These technical features yield the technical effect of being able to determine an accurate system power cap when the computing system is in a redundant mode, such as using a higher limit than might be used in a non-redundant mode.

In some examples of the apparatus, the system power cap comprises a non-redundant power limit when the computing system does not include a redundant power supply unit. These technical features yield the technical effect of being able to determine an accurate system power cap when the computing system is in a non-redundant mode, such as using a lower limit than might be used in a redundant mode.

In some examples of the apparatus, the memory further stores computer program instructions that, when executed, cause the processing device to determine, after a power supply unit has been added to or removed from the computing system, an updated version of the power supply configuration information. These technical features yield the technical effect of being able to dynamically update the power supply configuration information when the number of power supply units in the computing system changes.

In some examples of the apparatus, the memory further stores computer program instructions that, when executed, cause the processing device to determine, based on the updated version of the power supply configuration information, an updated system power cap for the computing system; and control power consumption of the computing system based on the updated system power cap. These technical features yield the technical effect of providing the ability to populate different numbers of power supply units and determine an accurate system power cap based on the current configuration and as the configuration changes.

Another example of the present disclosure is directed to a computer program product comprising a computer readable storage medium. The computer readable storage medium comprises computer program instructions that, when executed: determine power supply configuration information for a computing system, including a total number of power supply units in the computing system, a power supply type for each of the power supply units, and a power supply input voltage for each of the power supply units; determine, based on the power supply configuration information, a system power cap for the computing system; and control power consumption of the computing system based on the system power cap.

Examples of the computer program product include various technical features that yield technical effects that provide various improvements to computer technology. For instance, some examples include the technical features of determine power supply configuration information for a computing system, including a total number of power supply units in the computing system, a power supply type for each of the power supply units, and a power supply input voltage for each of the power supply units; determine, based on the power supply configuration information, a system power cap for the computing system; and control power consumption of the computing system based on the system power cap. These technical features yield the technical effect of providing support for multiple power caps that may be varied based on configuration information including multiple variables. Some examples support granularity in power supply configuration and being able to protect the system from going over the supplied power. Some examples allow usage of fewer or different types of power supplies when appropriate and no fixed power supply type to line cord input voltage relationship. Having the configuration based power capping capability allows the ability to tune the power supply configuration to the system requirements.

In some examples of the computer program product, the computer readable storage medium further comprises computer program instructions that, when executed: determine, based on the power supply type for each of the power supply units, a system level power supply type, where the system power cap for the computing system is determined based on the system level power supply type. These technical features yield the technical effect of being able to determine an accurate system power cap when mixed power supply types exist in the computing system.

In some examples of the computer program product, the computer readable storage medium further comprises computer program instructions that, when executed: determine, based on the power supply input voltage for each of the power supply units, a system level power supply input voltage, where the system power cap for the computing system is determined based on the system power supply input voltage. These technical features yield the technical effect of being able to determine an accurate system power cap when mixed power supply input voltages exist in the computing system.

In some examples of the computer program product, the system power cap comprises a redundant power limit when the computing system includes one or more redundant power supply units. These technical features yield the technical effect of being able to determine an accurate system power cap when the computing system is in a redundant mode, such as using a higher limit than might be used in a non-redundant mode.

In some examples of the computer program product, the system power cap comprises a non-redundant power limit when the computing system does not include a redundant power supply unit. These technical features yield the technical effect of being able to determine an accurate system power cap when the computing system is in a non-redundant mode, such as using a lower limit than might be used in a redundant mode.

Another example of the present disclosure is directed to a system, which includes one or more power consuming components, and one or more power supply units. The system includes a power management controller configured to determine power supply configuration information for the system, including a total number of the power supply units in the system, a power supply type for each of the power supply units, and a power supply input voltage for each of the power supply units. The power management controller is further configured to determine, based on the power supply configuration information, a system power cap for the system. The power management controller is further configured to control power consumption of the one or more power consuming components based on the system power cap.

Examples of the system include various technical features that yield technical effects that provide various improvements to computer technology. For instance, some examples include the technical features of determine power supply configuration information for the system, including a total number of power supply units in the system, a power supply type for each of the power supply units, and a power supply input voltage for each of the power supply units; determine, based on the power supply configuration information, a system power cap for the system; and control power consumption of the one or more power consuming components based on the system power cap. These technical features yield the technical effect of providing support for multiple power caps that may be varied based on configuration information including multiple variables. Some examples support granularity in power supply configuration and being able to protect the system from going over the supplied power. Some examples allow usage of fewer or different types of power supplies when appropriate and no fixed power supply type to line cord input voltage relationship. Having the configuration based power capping capability allows the ability to tune the power supply configuration to the system requirements.

In some examples of the system, the power management controller is configured to determine, based on the power supply type for each of the power supply units, a system level power supply type, where the system power cap for the system is determined based on the system level power supply type. These technical features yield the technical effect of being able to determine an accurate system power cap when mixed power supply types exist in the computing system.

In some examples of the system, the power management controller is configured to determine, based on the power supply input voltage for each of the power supply units, a system level power supply input voltage, where the system power cap for the system is determined based on the system power supply input voltage. These technical features yield the technical effect of being able to determine an accurate system power cap when mixed power supply input voltages exist in the computing system.

Another example of the present disclosure is directed to a method for power supply configuration based power capping, which includes determining, by a power management controller of a computing system that includes one or more power supply units, power supply configuration information for the computing system, including a total number of the power supply units, a power supply type for each of the power supply units, and a power supply input voltage for each of the power supply units. The method includes determining, by the power management controller based on the power supply configuration information, a system power cap for the computing system. The method includes controlling, by the power management controller, power consumption of the computing system based on the system power cap. The method includes updating, by the power management controller in response to a power supply unit being added to or removed from the computing system, the system power cap.

Examples of the method include various technical features that yield technical effects that provide various improvements to computer technology. For instance, some examples include the technical features of determining power supply configuration information for a computing system that includes one or more power supply units, including a total number of the power supply units, a power supply type for each of the power supply units, and a power supply input voltage for each of the power supply units; determining, based on the power supply configuration information, a system power cap for the computing system; controlling power consumption of the computing system based on the system power cap; and updating, by the power management controller in response to a power supply unit being added to or removed from the computing system, the system power cap. These technical features yield the technical effect of providing support for multiple power caps that may be varied based on configuration information including multiple variables. Some examples support granularity in power supply configuration and being able to protect the system from going over the supplied power. Some examples allow usage of fewer or different types of power supplies when appropriate and no fixed power supply type to line cord input voltage relationship. Having the configuration based power capping capability allows the ability to dynamically update the power supply configuration information when the number of power supply units in the computing system changes and tune the power supply configuration to the system requirements.

Some examples of the method further include determining, by the power management controller based on the power supply type for each of the power supply units, a system level power supply type, where the system power cap for the computing system is determined based on the system level power supply type. These technical features yield the technical effect of being able to determine an accurate system power cap when mixed power supply types exist in the computing system.

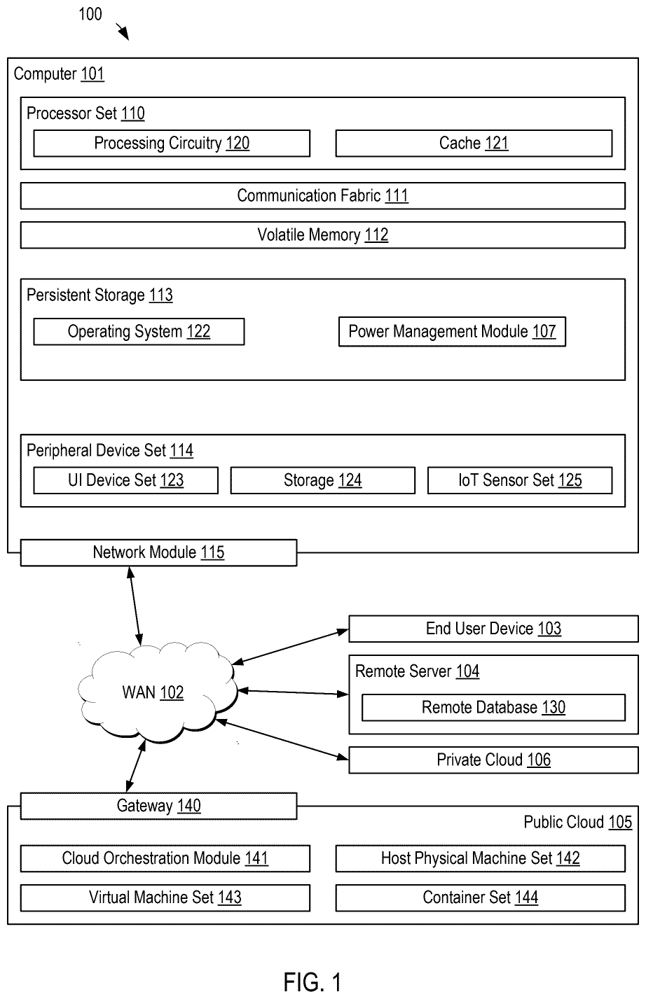

FIG. 1 sets forth an example computing environment according to aspects of the present disclosure. Computing environment 100 contains an example of an environment for the execution of at least some of the computer code involved in performing the various methods described herein, such as power management module 107. In addition to power management module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and power management module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in power management module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in power management module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

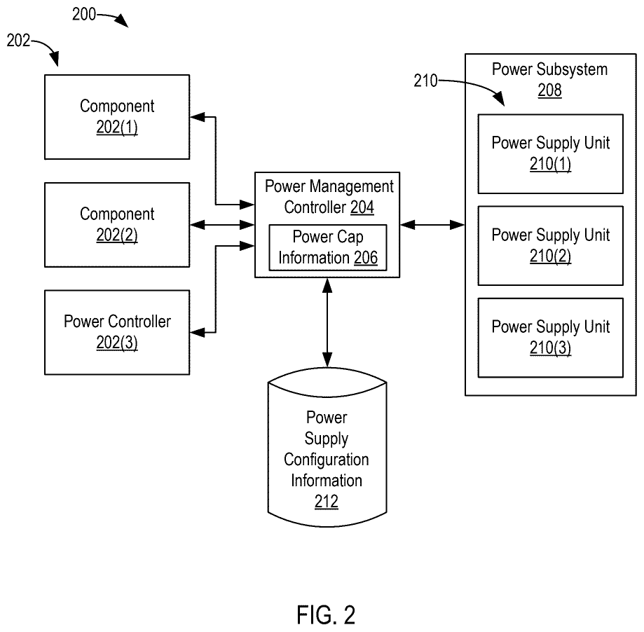

FIG. 2 sets forth an example system 200 for power supply configuration based power capping according to aspects of the present disclosure. In some examples, system 200 is implemented as part of computing environment 100 (FIG. 1). System 200 includes components 202(1)-202(3) (collectively referred to as components 202), power management controller 204, and power subsystem 208. Components 202 correspond to devices such as a central processing unit (CPU), a graphic processing unit (GPU), a memory, a field programmable gate array (FPGA), etc. Power subsystem 208 includes power supply units (PSUs) 210(1)-210(3) (collectively referred to as PSUs 210). Each of the PSUs 210 may be coupled via a power cable or line cord to a power distribution unit (PDU) or a wall outlet, which provides input power at a particular input voltage. Although three components 202 are shown in the illustrated example, other examples of system 200 may include more or less than three components 202. Although three PSUs 210 are shown in the illustrated example, other examples of system 200 may include more or less than three PSUs 210.

In some examples, power management controller 204 executes power management module 107 (FIG. 1) to perform one or more power management functions described herein. The power management controller 204 may be implemented as any combination of hardware, software, or firmware. The term “controller” is used to describe the component or set of components that are responsible for implementing the power management functionality and not to create a distinction between a “controller” and a “processor”. In other words, while the terms “controller” and “processor” may be used in the descriptions to describe separate components, a controller can be a processor and vice versa. Further, the controller can be implemented using hardware, software, or firmware that implements other functionality in addition to the power management functionality.

The power management controller 204 communicates with power subsystem 208 to obtain configuration information for PSUs 210, which may be stored as power supply configuration information 212. The power supply configuration information 212 may include the total number of the PSUs 210, a power supply type of each of the PSUs 210, and the type of the line cord input voltage attached to each of the PSUs 210. The power supply configuration information 212 may also include information indicating whether one or more of the PSUs 210 are redundant power supply units.

In some examples, based on the power supply configuration information 212, power management controller 204 determines power cap information 206 specific to the configuration indicated by the power supply configuration information 212. The power cap information 206 may include a redundant power limit for when the system 200 is operating in a redundant mode with one or more of the PSUs 210 being a redundant PSU, and/or a non-redundant power limit for when the system 200 is operating in a non-redundant mode with none of the PSUs 210 being a redundant PSU. In some examples, power management controller 204 may use a rules-based framework to determine the power cap information 206. Included in the rules-based framework according to some examples is a priority list of power supply types and input voltages, allowing the power management controller 204 to determine a power cap when mixed power supply configurations exist in the system 200.

In some examples, the power management controller 204 controls components 202 to keep the power usage or consumption of the system 200 under the limit indicated by the power cap information 206. The power management controller 204 may control each of the components 202 of the system 200 through a set of power usage controls (PUCs). The PUC for a component may include supply voltage setting, clock frequency setting, data rate, and other settings that may affect the power usage of the component. The power management controller 204 may determine a total power usage of the system 200 based on the settings of the PUCs provided to the individual components 202. The power management controller 204 may also determine the total power usage based on a power measurement of the system 200. Total power usage of the system 200 may also be referred to as total system power.

The power management controller 204 controls the total power usage of the system 200 to meet or satisfy the power cap indicated in the power cap information 206. In some examples, the total power usage of the system 200 may be considered to have met or satisfied the power cap when it is within a threshold range of the power cap. In some embodiments, the power management controller 204 controls the total power usage of the system 200 by throttling the power usages of the different components 202 of the system.

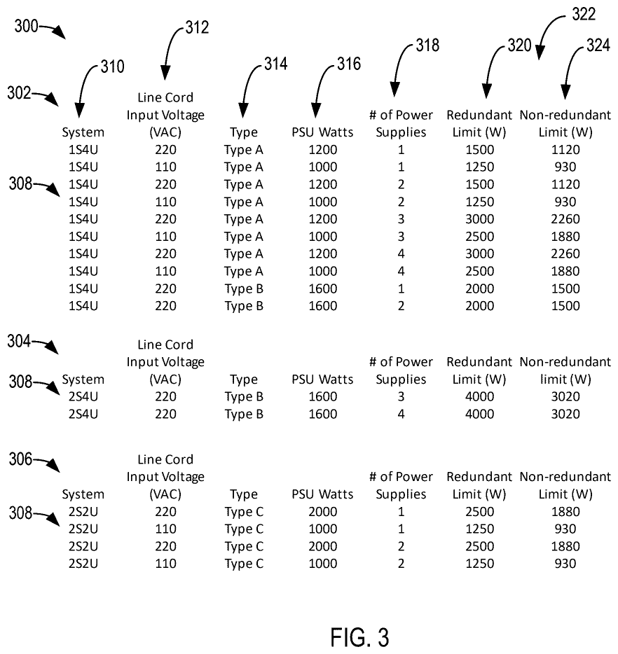

FIG. 3 sets forth example power supply configuration variations 300 according to aspects of the present disclosure. FIG. 3 illustrates the multiple variables that may impact the power available in a system, such as system 200 (FIG. 2). The power supply configuration variations 300 include three examples 302, 304, and 306 of configuration variations. Each of the examples 302, 304, and 306 includes a plurality of different possible power supply configurations 308, which are represented by horizontal rows. Example 302 includes ten possible power supply configurations 308. Example 304 includes two possible power supply configurations 308. Example 306 includes four possible power supply configurations 308. The vertical columns in FIG. 3 each correspond to a particular type of configuration information in the power supply configurations 308, and include system column 310, line cord input voltage (VAC) column 312, power supply type column 314, PSU watts column 316, and number (#) of power supplies column 318. The vertical columns also include power cap information 322, which includes redundant limit (W) column 320 and non-redundant limit (W) column 324.

Examples 302, 304, and 306 represent different power supply configurations that may be supported by a given system. In example 302, there are four supported numbers of power supplies (e.g., 1, 2, 3, and 4 in column 318), two supported power supply types (e.g., Type A and Type B in column 314), and two supported line cord input voltages (e.g., 110 VAC and 220 VAC in column 312). Although 110 VAC and 220 VAC are given as examples in FIG. 3, other systems may use other line cord input voltages, and these may vary based on geographic location. For each of the ten different power supply configurations 308 in example 302, power cap information 322 may be determined (e.g., by power management controller 204 (FIG. 2)), and may include a redundant limit (column 320) and a non-redundant limit (column 324). It is noted that the first through the eighth rows in example 302 use a 1200W PSU, but the second, fourth, sixth, and eighth rows use a 110 VAC line cord input voltage, rather than 220 VAC, which results in lower values in columns 316, 320, and 324.

In example 304, there are two supported numbers of power supplies (e.g., 3 and 4 in column 318), one supported power supply type (e.g., Type B in column 314), and one supported line cord input voltage (e.g., 220 VAC in column 312). For each of the two different power supply configurations 308 in example 304, power cap information 322 may be determined (e.g., by power management controller 204 (FIG. 2)), and may include a redundant limit (column 320) and a non-redundant limit (column 324).

In example 306, there are two supported numbers of power supplies (e.g., 1 and 2 in column 318), one supported power supply type (e.g., Type C in column 314), and two supported line cord input voltages (e.g., 110 VAC and 220 VAC in column 312). For each of the four different power supply configurations 308 in example 306, power cap information 322 may be determined (e.g., by power management controller 204 (FIG. 2)), and may include a redundant limit (column 320) and a non-redundant limit (column 324). It is noted that the first through the fourth rows in example 306 use a 2000W PSU, but the second and fourth rows use a 110 VAC line cord input voltage, rather than 220 VAC, which results in lower values in columns 316, 320, and 324.

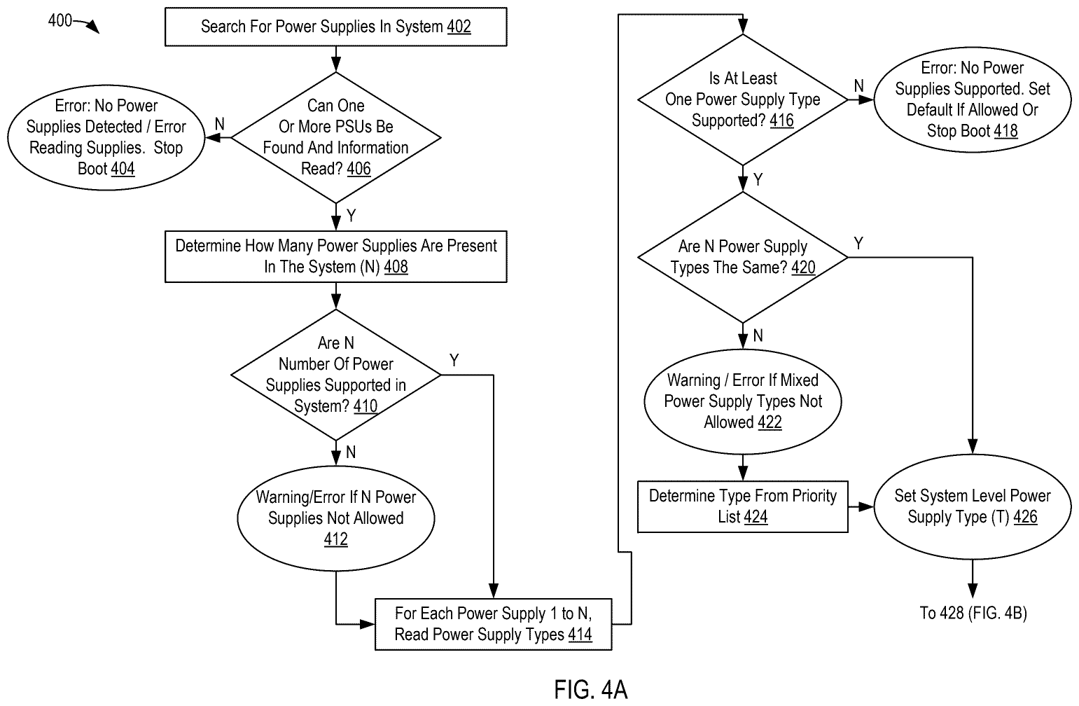

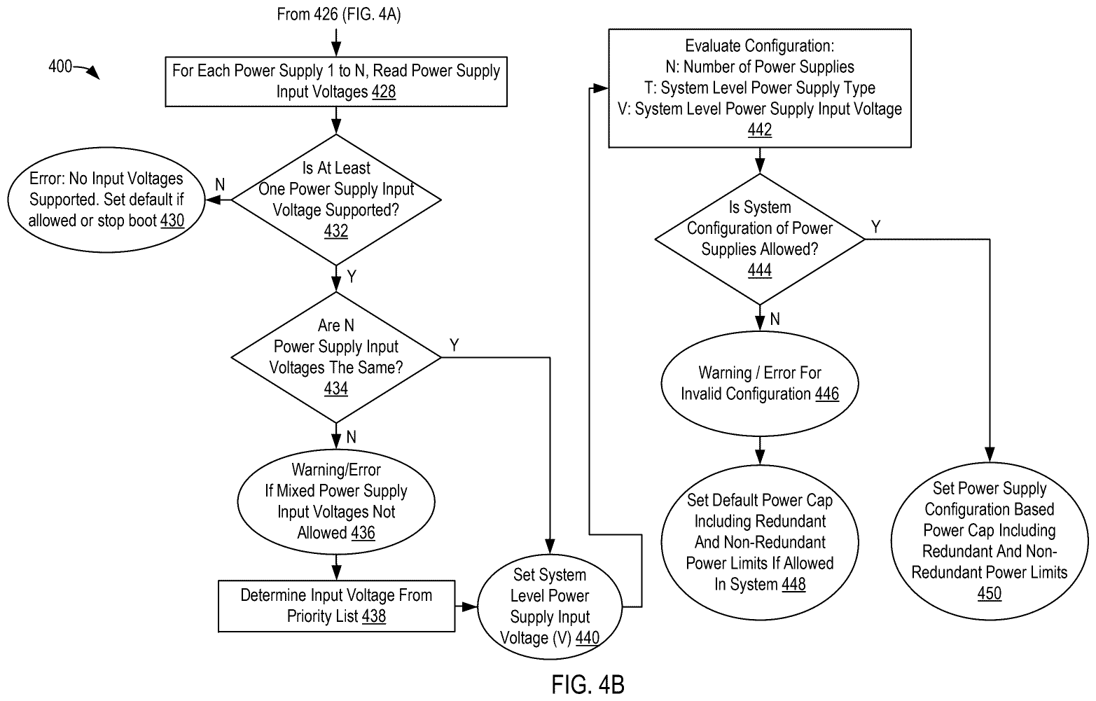

FIGS. 4A and 4B set forth a flowchart of an example method 400 for power supply configuration based power capping according to aspects of the present disclosure. In a particular embodiment, the method 400 is performed utilizing power management module 107 (FIG. 1) and power management controller 204 (FIG. 2). With reference to FIG. 4A, the method 400 at 402 includes searching for power supplies in the system. At 406 in method 400, it is determined whether one or more PSUs can be found and information read from the PSUs. If it is determined at 406 that one or more PSUs cannot be found or information cannot be read from the PSUs, the method 400 moves to 404, where an error may be generated that indicates no power supplies detected/error reading supplies, and a boot process may be stopped. If it is determined at 406 that one or more PSUs can be found and information can be read from the PSUs, the method 400 moves to 408, where the number of power supplies in the system is determined. The number of power supplies in the system determined at 408 is represented by “N”.

At 410 in method 400, it is determined whether N number of power supplies are supported in the system. If it is determined at 410 that N number of power supplies are not supported in the system, the method 400 moves to 412, where a warning/error may be generated indicating that N power supplies are not allowed or supported, and the method 400 moves to 414. If it is determined at 410 that N number of power supplies are supported in the system, the method 400 moves to 414, where, for each power supply 1 to N, the power supply type is read from the power supply.

At 416 in method 400, it is determined whether at least one of the power supply types identified at 414 is supported by the system. If it is determined at 416 that at least one of the power supply types identified at 414 is not supported by the system, the method 400 moves to 418, where an error is generated that indicates that no power supplies are supported, and a default is set if allowed, or a boot process is stopped. If it is determined at 416 that at least one of the power supply types identified at 414 is supported by the system, the method 400 moves to 420, where it is determined whether the power supply types for the N power supplies are the same. If it is determined at 420 that the power supply types for the N power supplies are the same, the method 400 moves to 426. If it is determined at 420 that the power supply types for the N power supplies are not the same, the method moves to 422.

At 422 in method 400, a warning/error is generated if mixed power supply types are not allowed or supported. At 424, a system level power supply type is determined from a priority list. The priority list may be a priority list of power supply types to facilitate determining a system level power supply type for configurations with mixed power supply types. At 426, a system level power supply type is set. The system level power supply type that is set at 426 is represented by “T”. For examples in which the power supply types for the N power supplies are the same, the system level power supply type may be the same as the individual power supply types. For examples in which the power supply types for the N power supplies are not the same, the system level power supply type may be the type determined at 424 from the priority list. The method then moves from 426 to 428 (FIG. 4B).

With reference to FIG. 4B, at 428 in method 400, for each power supply 1 to N, the system reads power supply input voltages. At 432 in method 400, it is determined whether at least one power supply input voltage is supported. If it is determined at 432 that at least one power supply input voltage is not supported, the method 400 moves to 430, where an error is generated indicating no input voltages supported, and a default is set or a boot process is stopped. If it is determined at 432 that at least one power supply input voltage is supported, the method 400 moves to 434, where it is determined whether the N power supply input voltages are the same.

If it is determined at 434 that the N power supply input voltages are not the same, the method 400 moves to 436. If it is determined at 434 that the N power supply input voltages are the same, the method 400 moves to 440. At 436 in method 400, a warning/error is generated if mixed power supply input voltages are not allowed. At 438 in method 400, a system level power supply input voltage is determined from a priority list, and the method 400 moves to 440. The priority list may be a priority list of power supply input voltages to facilitate determining a system level power supply input voltage for configurations with mixed power supply input voltages. At 440, a system level power supply input voltage is set. The system level power supply input voltage that is set at 440 is represented by “V”. For examples in which the power supply input voltages for the N power supplies are the same, the system level power supply input voltage may be the same as the individual power supply input voltages. For examples in which the power supply input voltages for the N power supplies are not the same, the system level power supply input voltage may be determined at 438 from the priority list.

At 442 in method 400, the system power supply configuration is evaluated, including: N: Number of power supplies; T: System level power supply type; and V: System level power supply input voltage. At 444 in method 400, it is determined whether the system configuration of power supplies is allowed. If it is determined at 444 that the system configuration of power supplies is allowed, the method 400 moves to 450, where a power supply configuration based power cap is set, including redundant and non-redundant power limits. If it is determined at 444 that the system configuration of power supplies is not allowed, the method 400 moves to 446, where a warning/error is generated indicating an invalid configuration. At 448 in method 400, if allowed in the system, a default power cap is set, including redundant and non-redundant power limits.

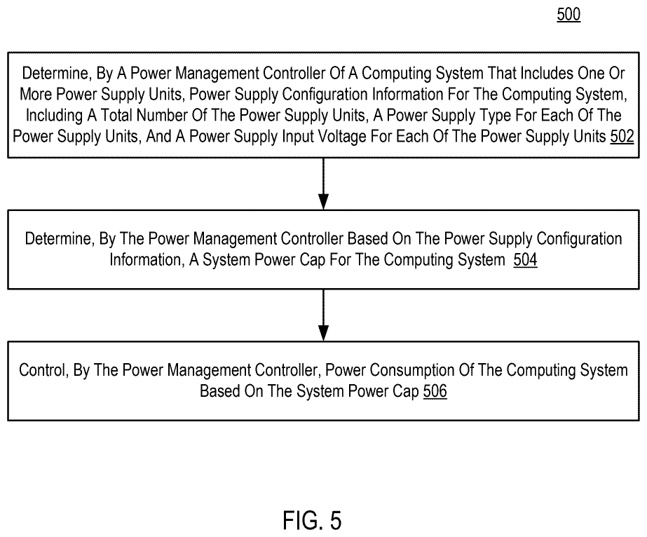

FIG. 5 sets forth a flowchart of an example method 500 for power supply configuration based power capping according to further aspects of the present disclosure. In a particular embodiment, the method 500 is performed utilizing power management module 107 (FIG. 1) and power management controller 204 (FIG. 2). Method 500 includes determining 502, by a power management controller of a computing system that includes one or more power supply units, power supply configuration information for the computing system, including a total number of the power supply units, a power supply type for each of the power supply units, and a power supply input voltage for each of the power supply units. Method 500 includes determining 504, by the power management controller based on the power supply configuration information, a system power cap for the computing system. Method 500 includes controlling 506, by the power management controller, power consumption of the computing system based on the system power cap.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for power supply configuration based power capping, comprising:
determining, by a power management controller of a computing system that includes one or more power supply units, power supply configuration information for the computing system, including a total number of the power supply units, a power supply type for each of the power supply units, and a power supply input voltage for each of the power supply units;
determining, by the power management controller based on the power supply configuration information, a system power cap for the computing system; and
controlling, by the power management controller, power consumption of the computing system based on the system power cap.

2. The method of claim 1, and further comprising:
determining, by the power management controller based on the power supply type for each of the power supply units, a system level power supply type, wherein the system power cap for the computing system is determined based on the system level power supply type.

3. The method of claim 1, and further comprising:
determining, by the power management controller based on the power supply input voltage for each of the power supply units, a system level power supply input voltage, wherein the system power cap for the computing system is determined based on the system power supply input voltage.

4. The method of claim 1, wherein the system power cap comprises a redundant power limit when the computing system includes one or more redundant power supply units.

5. The method of claim 1, wherein the system power cap comprises a non-redundant power limit when the computing system does not include a redundant power supply unit.

6. The method of claim 1, and further comprising:
determining, by the power management controller after a power supply unit has been added to or removed from the computing system, an updated version of the power supply configuration information.

7. The method of claim 6, and further comprising:
determining, by the power management controller based on the updated version of the power supply configuration information, an updated system power cap for the computing system; and
controlling, by the power management controller, power consumption of the computing system based on the updated system power cap.

8. The method of claim 1, and further comprising:
determining whether the power supply configuration information indicates an invalid power supply configuration; and
generating a warning indicating an invalid power supply configuration.

9. An apparatus comprising:
a processing device; and
memory operatively coupled to the processing device, wherein the memory stores computer program instructions that, when executed, cause the processing device to:
determine power supply configuration information for a computing system, including a total number of power supply units in the computing system, a power supply type for each of the power supply units, and a power supply input voltage for each of the power supply units;
determine, based on the power supply configuration information, a system power cap for the computing system; and
control power consumption of the computing system based on the system power cap.

10. The apparatus of claim 9, wherein the memory further stores computer program instructions that, when executed, cause the processing device to:
determine, based on the power supply type for each of the power supply units, a system level power supply type, wherein the system power cap for the computing system is determined based on the system level power supply type.

11. The apparatus of claim 9, wherein the memory further stores computer program instructions that, when executed, cause the processing device to:
determine, based on the power supply input voltage for each of the power supply units, a system level power supply input voltage, wherein the system power cap for the computing system is determined based on the system power supply input voltage.

12. The apparatus of claim 9, wherein the system power cap comprises a redundant power limit when the computing system includes one or more redundant power supply units.

13. The apparatus of claim 9, wherein the system power cap comprises a non-redundant power limit when the computing system does not include a redundant power supply unit.

14. The apparatus of claim 9, wherein the memory further stores computer program instructions that, when executed, cause the processing device to:
determine, after a power supply unit has been added to or removed from the computing system, an updated version of the power supply configuration information.

15. The apparatus of claim 14, wherein the memory further stores computer program instructions that, when executed, cause the processing device to:
determine, based on the updated version of the power supply configuration information, an updated system power cap for the computing system; and
control power consumption of the computing system based on the updated system power cap.

16. A computer program product comprising a computer readable storage medium, wherein the computer readable storage medium comprises computer program instructions that, when executed:
determine power supply configuration information for a computing system, including a total number of power supply units in the computing system, a power supply type for each of the power supply units, and a power supply input voltage for each of the power supply units;
determine, based on the power supply configuration information, a system power cap for the computing system; and
control power consumption of the computing system based on the system power cap.

17. The computer program product of claim 16, wherein the computer readable storage medium further comprises computer program instructions that, when executed:
determine, based on the power supply type for each of the power supply units, a system level power supply type, wherein the system power cap for the computing system is determined based on the system level power supply type.

18. The computer program product of claim 16, wherein the computer readable storage medium further comprises computer program instructions that, when executed:
determine, based on the power supply input voltage for each of the power supply units, a system level power supply input voltage, wherein the system power cap for the computing system is determined based on the system power supply input voltage.

19. The computer program product of claim 16, wherein the system power cap comprises a redundant power limit when the computing system includes one or more redundant power supply units.

20. The computer program product of claim 16, wherein the system power cap comprises a non-redundant power limit when the computing system does not include a redundant power supply unit.

21. A system comprising:
one or more power consuming components;
one or more power supply units; and
a power management controller configured to:
determine power supply configuration information for the system, including a total number of the power supply units in the system, a power supply type for each of the power supply units, and a power supply input voltage for each of the power supply units;
determine, based on the power supply configuration information, a system power cap for the system; and
control power consumption of the one or more power consuming components based on the system power cap.

22. The system of claim 21, wherein the power management controller is configured to:
determine, based on the power supply type for each of the power supply units, a system level power supply type, wherein the system power cap for the system is determined based on the system level power supply type.

23. The system of claim 21, wherein the power management controller is configured to:
determine, based on the power supply input voltage for each of the power supply units, a system level power supply input voltage, wherein the system power cap for the system is determined based on the system power supply input voltage.

24. A method for power supply configuration based power capping, comprising:
determining, by a power management controller of a computing system that includes one or more power supply units, power supply configuration information for the computing system, including a total number of the power supply units, a power supply type for each of the power supply units, and a power supply input voltage for each of the power supply units;
determining, by the power management controller based on the power supply configuration information, a system power cap for the computing system;
controlling, by the power management controller, power consumption of the computing system based on the system power cap; and
updating, by the power management controller in response to a power supply unit being added to or removed from the computing system, the system power cap.

25. The method of claim 24, and further comprising:
determining, by the power management controller based on the power supply type for each of the power supply units, a system level power supply type, wherein the system power cap for the computing system is determined based on the system level power supply type.
